(19) United States
(12) Patent Application Publication
(10) Pub. No.: US 2004/0002859 A1
(43) Pub. Date: Jan. 1, 2004

(54) Method and architecture of digital conding for transmitting and packing audio signals

(76) Inventors: Chi-Min Liu, Hsinchu Hsien (TW); Wen-Chieh Lee, Taoyuan Hsien (TW)

Correspondence Address: SUPREME PATENT SERVICES, POST OFFICE BOX 2339, SARATOGA, CA, 95070, US

(21) Appl. No.: 10/184,157

(22) Filed: Jun. 26, 2002

(51) Int. Cl. G10L 19/02

(52) U.S. Cl. 704/229

(57) ABSTRACT

A method of digital coding transforms input audio signals into a sequence of frequency samples representing a spectral composition of the audio signals, and quantizes the sequence of frequency samples into quantized values according to a bit allocation process which uses a parameter predictor to evaluate quantization parameters by referring to a masking threshold. The quantized values are encoded into a number of bits of encoded data. An iterative rate control loop adjusts the quantization parameters and the quantization step size if the number of bits in the encoded data exceeds a prescribed number of bits available for the encoded data. The method may also cut off high frequency components of the input audio signals according to a cut-off frequency determined by the iterative rate control loop before quantizing the sequence of frequency samples.

### FIELD OF THE INVENTION

The present invention relates generally to a method and its architecture of digital coding for transmitting and packing signals and, in particular, to the bit allocation in the coding of audio signals.

### BACKGROUND OF THE INVENTION

The perceptual audio coding such as MPEG Layers 1-3, advanced audio coding, or T/F (Time/Frequency) coding, has been widely used in consumer electronics, telecommunications, and broadcasting. Among these perceptual audio coders, the bit allocation is one of the main tasks leading to the high complexity and the key module determining encoded quality.

FIG. 1 illustrates the block diagram of a coding process in perceptual audio coding. A T/F mapper 101 transforms the audio signals S(n) into frequency segments S(m, f) from time domain into frequency domain by a window-by-window basis. Various coders 103 have been used in the coding process to achieve high compression ratios. The output X(m,f) is the frequency domain sequence after coding with the window segment index m and the frequency index f. A quantizer 105 quantizes X(m,f) into a finite number of levels represented by X′(m,f) with the goal of minimizing the subjective impairments introduced by the quantization noise. The quantization levels are controlled through the quantization parameters.

The audio compression in general classifies the frequency lines into sets referred to as quantization bands. The number of lines grouped in a quantization band is determined according to the critical bands and the affordable bits that are required to transmit the quantization parameters. VLC (Variable length coding) 107 represents the quantized sequence X′(m,f) through a variable length coding with the consideration of the statistic occurrence probability of the transmitted signal. A packing unit 109 packs the final encoded sequence into a sequence defined by a specified audio protocol. A psychoacoustic model 111 analyzes the signals and provides SMR (signal-to-masking ratio) for the quantization bands from the signal analysis result. A bit-allocator 113 determines the quantization parameters with reference to the masking thresholds provided by the psychoacoustic model 111 and the available bit budget 115.

A non-uniform quantizer quantizes the spectral lines under the control of the bit allocator, which decides the quantization manners with the consideration of the resultant audio quality and the required bits. Hence control over the quality and the bit number is the fundamental requirement of the bit allocation. U.S. Pat. No. 5,579,430 discloses a digital encoding process related to the OCF (optimum coding in the frequency domain) process. It improves the OCF process in such a manner that encoding of music with a quality comparable to compact-disc quality is possible at a data rate of approximately 2 bits/ATW and with good FM-radio quality at a data rates of 1.5 bits/ATW. Another U.S. Pat. No. 5,924,060 discloses a digital coding process for the transmission and/or storage of acoustical signals, which reduces the data rate by a factor of 4 to 6 without subjectively degrading the quality of the musical signal.

For MPEG Layers 1 and 2, a uniform quantizer is utilized to control the quality and the bit requirement. Hence the bit allocation is simply to apportion the total number of bits available for the quantization of the sub-band signals to minimize the audibility of the quantization noise. For coders such as MPEG Layer 3, MPEG-2 AAC, and MPEG4 T/F coding, control over the quality and the bit rate is difficult. This is mainly due to the fact that they all use a non-uniform quantizer whose quantization noise varies with respect to the input values. In other words, it fails to control the quality by assigning quantizer parameters according to the perceptually allowable noise. In addition, the variable length coding used in MPEG Layer 3 and MPEG-2 ACC assigns variable bit-length to different values, which means that the bits consumed should be obtained from the quantization results, and cannot be from the quantizer parameters alone. Thus, the bit allocation is one of the main tasks leading to the high complexity of the encoder.

The above drawbacks lead to the problem in evaluating the quantization parameters. A two-nested loop iterative method referred to as the OCF has been proposed to solve the problem. As illustrated in FIG. 2, it evaluates the quantization parameters through two iteration loops, the rate-controlling loop and the quality-controlling loop. The rate-controlling loop iteratively adjusts the parameter values to fit to the limited bits obtained by performing quantization and Huffman coding for spectral lines. The quality-controlling loop iteratively adjusts the parameter values to fit to a perceptual criterion of the quantization noise that needs to be evaluated by performing the inverse quantization.

The complexity of the method for a frame with F spectral lines can be described as O(F·R·η+F·Q·γ), where Q and R are respectively the numbers of quality-controlling iterations and rate-controlling iterations while η and γ are the computation complexity to handle a spectral line in the rate-controlling loop and the quality-controlling loop, respectively. The rate-controlling loop complexity η is from the quantization and the VLC coding of a spectral line while the quality-controlling loop complexity γ is from the dequantization and noise measure. Both complexity η and γ are high. Also, the numbers of iterations Q and R depend on the initial values of quantization parameters and the adjustment methods. The complexity is even larger than the total complexity of the hybrid transform and the psychoacoustic model shown in FIG. 1.

Assigning bits to quantization bands in the quality-controlling loop determines the quality of the coded audio. There have been two approaches to assigning the bits. One approach is to assign the bit only to the band with the worst noise-to-masking ratio in each of the iterations in the loop. The approach leads to a large number of iterations in the quality-controlling loop, which means very high complexity. Another approach assigns bits to all the bands with a noise-to-masking ratio higher than one in each of the iteration until all available bits are consumed. This approach has a much lower complexity than the first approach. However, whether the quality of the approach is satisfactory is the concerns.

The first approach can shape the noise so that the masking threshold will be in parallel to the noise threshold, which has been a widely accepted criterion. The second approach that has been in the sample code provided by ISO usually leads to better subjective quality. The problems of the two nested loops method is that it may not lead to a convergent condition. Since there are two separate rules controlling the quality and bits consumed in two loops, it may lead to infinite loops, generally referred to as dead-lock problem. A general method to manage the deadlock problem is to set a limit to the maximum number of iterations, and use some heuristic parameter tuning method to take care of the quality and the loop number. However, the quality can not be guaranteed for these methods.

### SUMMARY OF THE INVENTION

This invention has been made to overcome the drawbacks of the conventional digital coding process. The primary object is to provide a method of digital coding for transmitting and packing audio signals with high quality and much less computing complexity.

According to the invention, input audio signals are first mapped into a sequence of frequency samples to represent a spectral composition of the audio signals. The sequence of frequency samples is quantized in accordance with a bit allocation process and a parameter predictor evaluating the quantization parameters by directly referring to a masking threshold. These quantized values are encoded with variable length coding or directly packed to a specified protocol. If the overall length of the encoded data exceeds the number of bits available, a parameter adjustment is made and the quantization step size is increased. This process is repeated until the number of bits available is greater than the number of required bits for the encoding. Finally, the final encoded sequence is packed into a sequence defined by a specified audio protocol.

The method of this invention takes a non-uniform quantizer of MPEG layer 3 for detail derivation and examines the issues of the complexity and audio quality of the perceptual encoding method. Accordingly, it uses segmental-noise-to-masking-ratio for the derivation, and provides a closed-form equation for the relationship between bits/step size and quantization noise. The method is not limited to MPEG Layer 3, it is applicable to most perceptual coders like MPEG AAC (advanced audio coding). It is also applicable to the coder with uniform quantizers such as MPEG Layer 1 and Layer 2 due to the new bit allocation criteria this invention provides.

Another object of the present invention is to provide the architecture for such a digital coding process. The architecture comprises a mapper, a quantizer, a VLC encoder, a parameter predictor, a packing unit, an adjustor, and a comparator that may be realized by signal processors to accomplish the method of this invention.

According to the present invention, the quantization parameters are evaluated directly from the quality criteria for the graceful degradation in consideration of the quantization bandwidth and the required bits in the non-equal frequency lines by means of a rate-controlling lop for low bit-rate audio coding process. For variable bit-rate coding, the iteration in rate-controlling loop can be removed completely.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 illustrates the block diagram of a coding process in modern audio coding.

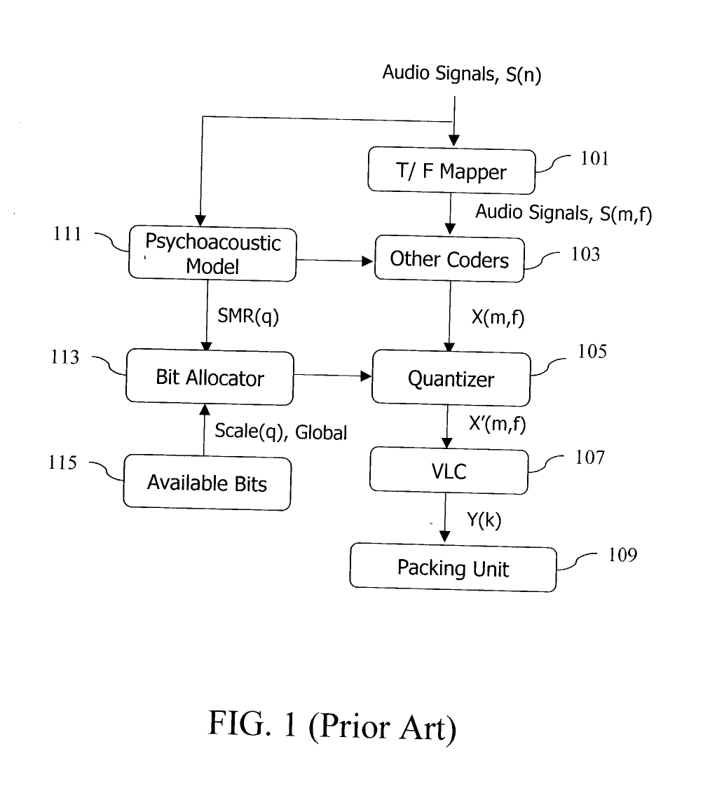

FIG. 2 illustrates the bit allocation process for an OCF process.

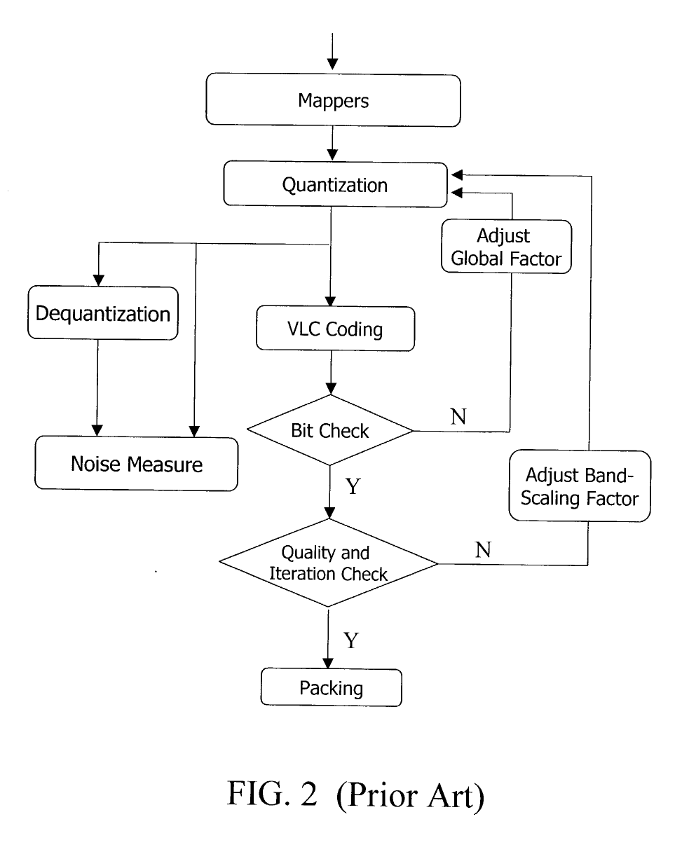

FIG. 3a illustrates the procedure of the audio coding process according to the present invention.

FIG. 3b illustrates the procedure of the low bit-rate audio coding process according to the present invention.

FIG. 3c illustrates the procedure of the variable bit-rate audio coding process according to the present invention.

FIG. 4a illustrates a realized architecture of FIG. 3a according to the present invention.

FIGS. 4b and 4c illustrate the realized architectures of FIGS. 3b and 3c respectively.

FIG. 5 illustrates the average iteration number for each granule in MPEG Layer 3 with different testing material for the present invention and the MPEG bit allocation process respectively.

FIG. 6 illustrates the objective score of the method of the invention compared to the bit allocation method suggested in ISO draft.

FIG. 7 provides a list with a subset of test signals that were used during the objective and subjective test.

### DETAILED DESCRIPTION OF THE INVENTION

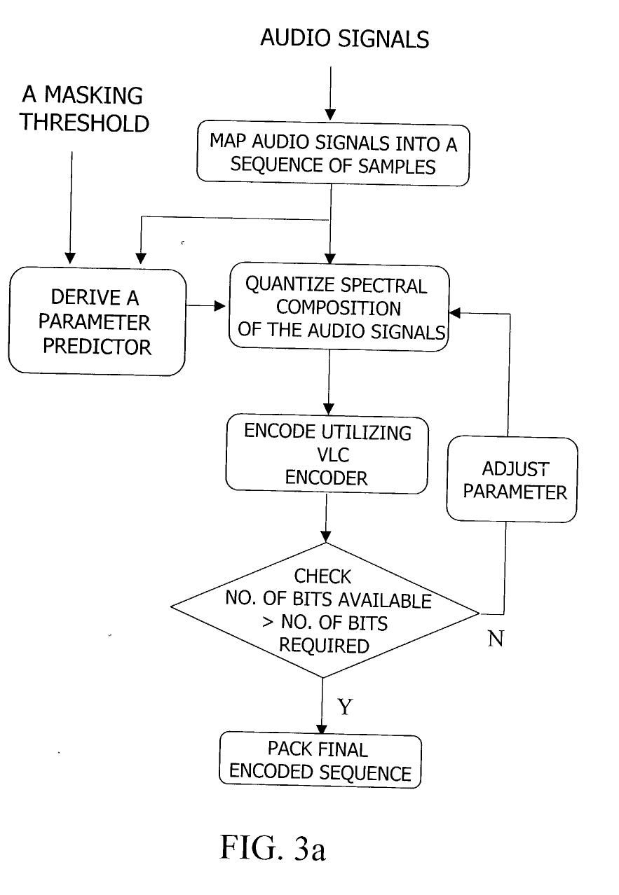

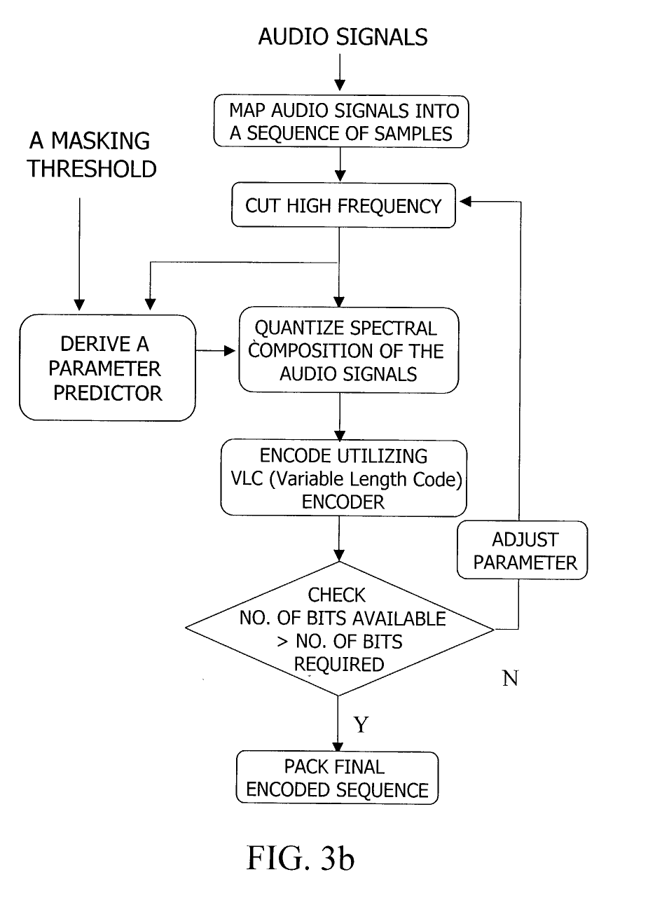

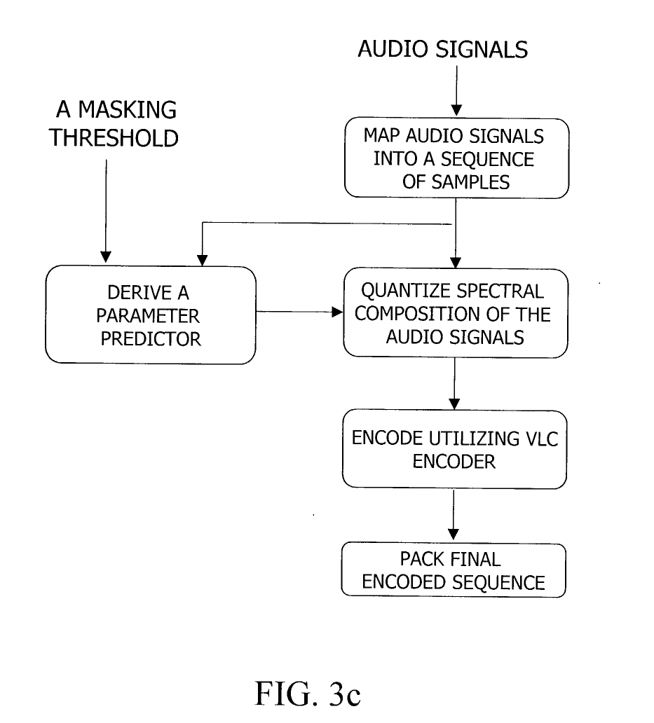

FIG. 3a illustrates the procedure of the audio coding method according to the present invention. Referring to FIG. 3a, input audio signals are first mapped into a sequence of frequency samples representing a spectral composition of the audio signals. This sequence of frequency samples is then quantized to obtain symbols with a lower precision according to a bit allocation process. A parameter predictor is used to evaluate the quantization parameters by directly referring to a masking threshold for the noise extent that a human hearing system can hear. The parameters determining the signal level resolution for a compression system are predicted.

These quantized symbols are encoded with a VLC encoder. The next step is checking if a prescribed number of bits available is enough or not for the encoded data. If the number of bits available is not greater than the overall length of the encoded data, a parameter adjustment is made and the quantization step size is increased. This process is repeated until the number of required bits for the encoding reaches the number of bits available. At the end, the final encoded sequence is packed into a sequence defined by a specified audio protocol.

For audio coding of a low bit-rate, the high frequency may be cut off before evaluating the quantization parameters in the parameter predictor. FIG. 3b illustrates the procedure of the low bit-rate audio coding process. As shown in FIG. 3b, while the number of required bits for the low bit-rate encoding exceeds the number of bits available, the cut-off frequency is adjusted and transmitted so that the high frequency components are cut off before evaluating the quantization parameters. The quantization step size may also be adjusted if desirable. For audio coding of a variable bit-rate, the available bits can be adjusted according to the required quality. In this case, the iteration in the rate control loop can be completely removed. FIG. 3c illustrates the procedure of the variable bit-rate audio coding process, in which the iteration in the rate control loop is removed from FIG. 3a.

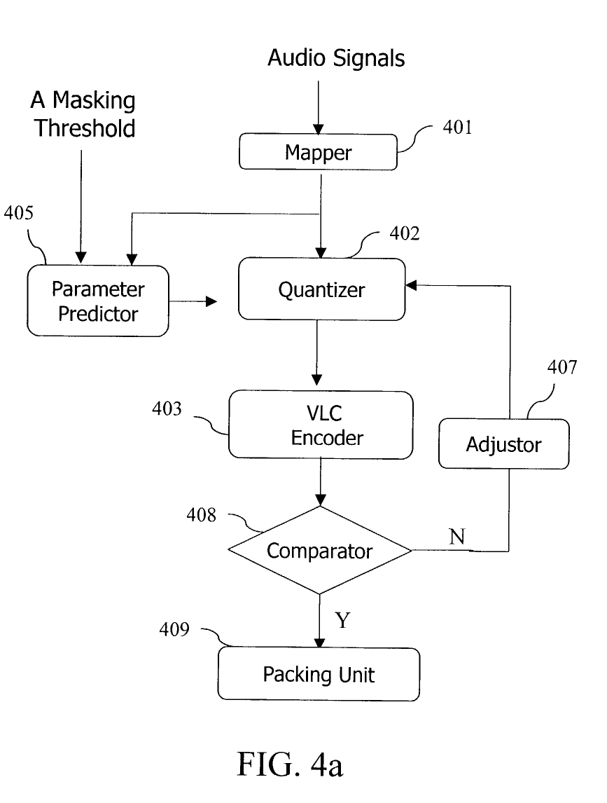

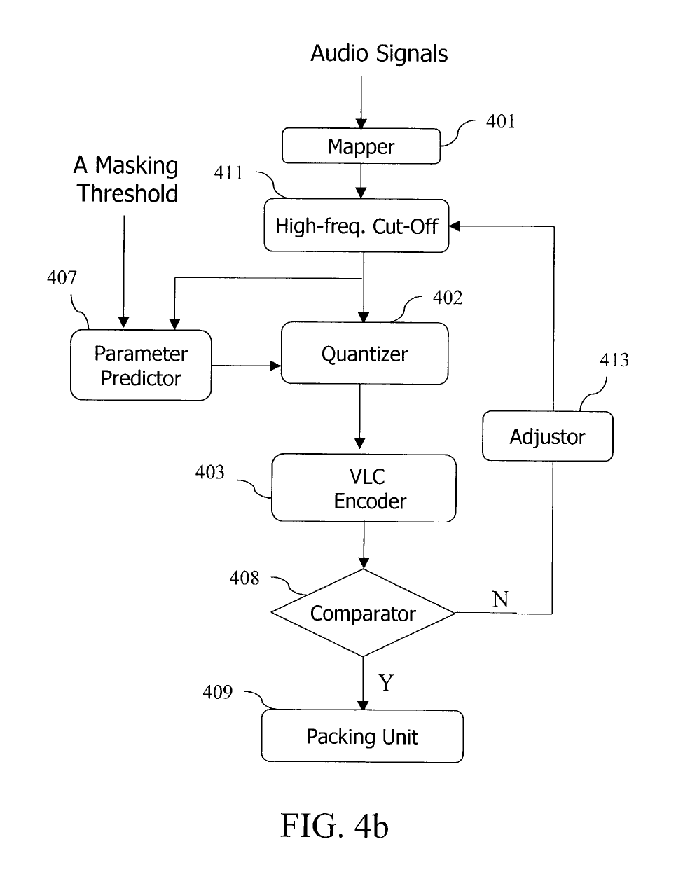

The procedures as shown in FIGS. 3a-3c of this invention may be realized with signal processors. The detailed architectures of the realization are disclosed as follows. In accordance with FIG. 3a, the realized architecture shown in FIG. 4a comprises a mapper 401 to receive and transform an input sequence of audio signals into a sequence of frequency samples to thereby represent a spectral composition of the audio signals. A quantizer 402 quantizes the sequence of frequency samples into a finite number of levels in accordance with a bit allocation process. A parameter predictor 405 is used to evaluate the quantization parameters by directly referring to a masking threshold, and an optimum encoder 403 encodes the quantized levels. An adjustor 407 adjusts the quantization parameters when the number of bits available is not enough for the encoded data and a comparator 408 compares a prescribed number of bits available and the required length of the encoded data to check if the number of bits available is enough or not for the encoded data. A packing unit 409 packs the final encoded sequence into a sequence defined by a specified audio protocol.

FIGS. 4b and 4c illustrate the realized architectures of FIGS. 3b and 3c respectively. Referring to FIG. 4b, an adjustor 413 is used to adjust the cut-off frequency and transmit it to a high-frequency cut-off unit 411 in the case of low bit-rate audio coding. The adjustor 413 may also adjust the quantization step size used in the quantizer 402. The high-frequency cut-off unit 411 is added between the mapper 401 and the quantizer 402 to receive the adjusted cut-off frequency and transmit it to the parameter predictor 405. In the case of variable bit-rate coding, the elements related to the iteration in the rate control loop are simply removed as shown in FIG. 4c.

In the invention, a deterministic formula based on a constant masking-to-noise ratio ρ is derived to calculate the quantization parameters for the parameter predictor in the bit allocation process. It provides a closed-form equation of the noise predictor for a non-uniform quantizer. This invention takes MPEG Layer 3 as the detailed derivation and experiment example. For a MPEG ACC quantizer, a similar process is applicable.

The bit allocation of the present invention meets the requirement of bit rate and noise shaping for each sub-band by single step prediction. An optimum global factor and a scaling factor for each sub-band are evaluated by directly referring to a masking threshold. The global factor controls the overall number of consumed bits, and the scaling factor controls the quantization noise of the associated band relative with the other bands. The following paragraphs first illustrate the bit allocation criteria, then derive in more detail the noise predictor and bounds on a scale factor under the constraint from the zero band and negative noise-to-masking ratio (NMR).

Bit Allocation Criteria

Firstly, the minimum over segmental NMR is considered:

$$R ( i ) = arg {Min}_{R ( i )} {\sum }_{i}^{} \{ ( \frac{{σ}_{N ( i )}^{2}}{{σ}_{M ( i )}^{2}} ) \} , \qquad ( 1 )$$

where

$${σ}_{N ( i )}^{2} and {σ}_{M ( i )}^{2}$$

are the noise energy and the masking energy associated with the critical band i. R(i) is the bit rate to minimize the segmental NMR. In an R(i) bits/sample PCM coder, the quantization error variance is given by

$$N ( i ) = {ρ2}^{- 2 R ( i )} {σ}_{x ( i )}^{2} \qquad ( 2 )$$

So, the minimization

$$arg {Min}_{R ( i )} {\sum }_{i}^{} \{ ( \frac{{ρ2}^{- 2 R ( i )} {σ}_{x ( i )}^{2}}{{σ}_{M ( i )}^{2}} ) \} \qquad ( 3 )$$

should be constrained by the total bit rate; that is,

$${\sum }_{i}^{} \{ R ( i ) B ( i ) \} = R . \qquad ( 4 )$$

According to the method of Lagrange multipliers, the solution must satisfy

$$\frac{\partial }{\partial R ( j )} \{ ( {\sum }_{i}^{} \{ R ( i ) B ( i ) \} - R ) + λ {\sum }_{i}^{} \{ ( \frac{{ρ2}^{- 2 R ( i )} {σ}_{x ( i )}^{2}}{{σ}_{M ( i )}^{2}} ) \} \} = 0 , for all j . \\ Then λ = \frac{B ( j )}{( 2 log 2 ) ( \frac{{ρ2}^{- 2 R ( j ) )} {σ}_{x ( i )}^{2}}{{σ}_{M ( j )}^{2}} )} = \frac{B ( j )}{2 log 2 ( \frac{{σ}_{N ( j )}^{2}}{{σ}_{M ( j )}^{2}} )} , for all j . \qquad ( 5 )$$

So, R(j) should be allocated so that the noise-to-masking ratio is proportional to the B(j). That is

$${σ}_{N ( j )}^{2} = {κσ}_{M ( j )}^{2} B ( j ) , for all j . \qquad ( 6 )$$

The noise level should be kept proportional to the masking threshold multiplied by a bandwidth to have the best segmental NMR.

Secondly, the noise level for the quantization bands is selected in consideration of the masking threshold and critical bandwidth in the quantization band. In other words, the

$${σ}_{N ( q )}^{2}$$

instead of the

$${σ}_{N ( j )}^{2}$$

is to be found to minimize the segmental NMR

$${σ}_{N ( q )}^{2} = {κσ}_{M ( j )}^{2} B ( q ) \qquad ( 7 )$$

where q is the index of the quantization band. The problem is equivalent to finding B(q) to approximate best the energy defined to minimize the segmental NMR; that is

$$\hat{B} ( q ) = arg {Min}_{B ( q )} {\sum }_{j ∈ q} \vert {σ}_{N ( q )}^{2} - {σ}_{N ( j )}^{2} \vert \qquad ( 8 )$$

Assume that the masking energies of the critical bands in the quantization bands are uniform, the selection after calculation is

$$\hat{B} ( q ) = {Average }_{j ∈ q} ( B ( j ) ) \qquad ( 9 )$$

Thirdly, to avoid the bits allocated to the bands with masking level higher than the noise level, the criteria to minimize the segmental NMR is modified so that the bands with negative NMR should be rounded to 1. That is, the quantization noise for each band should have a lower bound. On the other hand, the noise higher than the masking threshold leads to a phenomenon that the associated band will be rounded to zero, referred to as the zero bands. The zero bands are quite perceptually noticeable. So, the quantization levels should also be restricted to be no larger than the signal energy.

To summarize, the bit allocation should be assigned with noise parallel to the multiplication between masking level and bandwidth under the constraints from the zero band and negative NMR.

Noise Predictor

An MPEG Layer 3 quantizer is taken as an example for the derivation of the noise predictor. From MPEG Layer 3 standard, the simplified formula for the non-uniform quantizer of layer 3 is

$${is}_{i} = int ( \frac{{xr}_{i}^{\frac{3}{4}}}{{Δ}_{q}} ) , \qquad ( 10 )$$

where the quantization step size is

$${Δ}_{sfb} = {2}^{\frac{3}{4} ( {gain}_{gi} - {scale}_{sfb} )} . \qquad ( 11 )$$

From the MPEG standard, the formula of the non-uniform quantizer can also be expressed as

$${is}_{i} = {int ( {xr}_{i} {2}^{{scale}_{q} - {gain}_{g r}} - 0.0946 )}^{\frac{3}{4}} , \qquad ( 12 )$$

where the scale factor is scale_{q}=½(1+scalefac_scale)(scalefac_{q}+preflag·pretab_{q}) for each quantization band q; scalefac_scale is 0 or 1, scalefac_{q} is in the range of 0˜-15, and the pre-amplified flag is preflag_{gr}·pretab_{q}; the global gain is gain_{gr}=½(global_gain_{gr}−210) for each granule of MPEG layer 3 frame. By ignoring 0.0946, (12) can be derived as

$$\begin{matrix}{is}_{i} = {int ( {xr}_{i} {2}^{{scale}_{q} - {gain}_{g r}} )}^{\frac{3}{4}} \\ = int ( {xr}_{i}^{\frac{3}{4}} {2}^{\frac{3}{4} ( {scale}_{q} - {gain}_{g r} )} ) \\ = int ( \frac{{xr}_{i}^{\frac{3}{4}}}{{Δ}_{q}} )\end{matrix} \qquad ( 13 )$$

where step size is

$${Δ}_{q} = {2}^{\frac{3}{4} ( {gain}_{gi} - {scale}_{q} )} .$$

Next, the input signal xr₁ and reconstructed signal xr₁ have the following two formulae:

$${xr}_{i} = {( ( {is}_{i} + {ϵ}_{i} ) {Δ}_{sfb} )}^{\frac{4}{3}} , and {xr}_{i} = {( {is}_{i} {Δ}_{sfb} )}^{\frac{4}{3}} .$$

The quantization error of the non-uniform quantizer e₁ will be equal to the difference of input signal xr₁ and reconstructed signal xr₁:

$$\begin{matrix}{e}_{i} = {xr}_{i} - {\tilde{xr}}_{i} = {( ( {is}_{i} + {ϵ}_{i} ) {Δ}_{sfd} )}^{\frac{4}{3}} - {( {is}_{i} {Δ}_{sfd} )}^{\frac{4}{3}} \\ = {( 1 + {is}_{i}^{- 1} {ϵ}_{i} )}^{\frac{4}{3}} {is}_{i}^{\frac{4}{3}} {Δ}_{sfd}^{\frac{4}{3}} - {( {is}_{i} {Δ}_{sfd} )}^{\frac{4}{3}}\end{matrix} \qquad ( 14 )$$

Let ƒ(εₗ)=(1+isᵢ⁻¹εₗ)^{4/3}. By Tyler expansion with the first order approximation of f(ε)≈1+f(ε)ε, this leads to

$${e}_{i} = f ( {ϵ}_{i} ) {is}_{i}^{\frac{4}{3}} {Δ}_{q}^{\frac{4}{3}} - {( {is}_{i} {Δ}_{q} )}^{\frac{4}{3}} \approx \frac{4}{3} {is}_{i}^{\frac{1}{3}} {ϵ}_{i} {Δ}_{q}^{\frac{4}{3}} .$$

Assume that the quantized signals is, and the quantized error of the uniform quantizer ε₁ are independent, the expectation of the quantization error of the non-uniform quantizer e, is as follows:

$$E [ {e}_{i}^{2} ] \approx \frac{16}{9} {Δ}_{q}^{\frac{8}{3}} E [ {IS}_{i}^{\frac{2}{3}} {ϵ}^{2} ] \approx \frac{16}{9} {Δ}_{q}^{\frac{8}{3}} E [ {IS}_{i}^{\frac{2}{3}} ] E [ {ϵ}_{i}^{2} ] \qquad ( 15 )$$

If the spectrum of the quantization bands is uniform, the noise of lines can be the average energy of quantization band; that is

E(e₁²)=E(e_{q}²) (16)

Since

$$E [ {ϵ}_{i}^{2} ] = \frac{1}{12} ,$$

(15) becomes

$$E [ {e}_{i}^{2} ] \approx \frac{4}{27} {Δ}_{q}^{\frac{8}{3}} E [ {( \frac{{XR}_{i}^{\frac{3}{4}}}{{Δ}_{q}} )}^{\frac{2}{3}} ] = \frac{4}{27} {Δ}_{q}^{2} E [ {\vert {XR}_{i} \vert}^{\frac{1}{2}} ] \qquad ( 17 )$$

Substituting (7) into (16) yields

$$E [ {e}_{i}^{2} ] = κ {σ}_{M ( q )}^{2} B ( q ) \qquad ( 18 )$$

Finally, by defining

$${T}_{q} = {σ}_{M ( q )}^{2} B ( q ) ,$$

the difference between the global gain and the scale factor is approximate to

$$\begin{matrix}{gain}_{g r } - {scale}_{q} \approx \frac{2}{3} {log}_{2} \frac{27}{4} κ \cdot {T}_{q}^{2} / E [ {\vert {XR}_{i} \vert}^{0.5} ] , \\ or \\ {gain}_{g r } - {scale}_{q} = \frac{2}{3} ( {log}_{2} \frac{27}{4} + {log}_{2} κ + {log}_{2} {T}_{q}^{2} - {log}_{2} E [ {\vert {XR}_{q} \vert}^{0.5} ] )\end{matrix} \qquad ( 19 )$$

Since the scale factor scale_{q} is in the range of 0˜16 and the minimum scale for these quantization bands must be zero, thus the global gain is

$${gain}_{g r } = {Max}_{q} \{ {gain}_{g r} - {scale}_{q} \} ,$$

and the scale factors for all sub-bands are obtained. It can be seen that the global gain varies with the bit rate related constant K, and the scale factor varies for each sub-band according to the masking threshold and the input signals.

Bounds on Scale Factors

As mentioned before, the bits should be allocated under non-negative NMR and the constraint of zero bands. For the non-negative NMR issues, the noise level is set to be the masking threshold; that is

$${T}_{q} = {σ}_{M ( q )}^{2}$$

and K=1. This yields to the upper bound of the U scale_{q} relative to the global scale.

$$\begin{matrix}{gain}_{g r } - {Uscale}_{q} = \frac{2}{3} ( {log}_{2} \frac{27}{4} + {log}_{2} {σ}_{M ( q )}^{2} - {log}_{2} E [ {\vert {XR}_{q} \vert}^{0.5} ] ) \\ That is , & ( 20 ) \\ {scale}_{q} \leq {Uscale}_{q} = {gain}_{g r } - \frac{2}{3} ( {log}_{2} \frac{27}{4} + {log}_{2} {σ}_{M ( q )}^{2} - {log}_{2} E [ {\vert {XR}_{q} \vert}^{0.5} ] ) & ( 21 )\end{matrix}$$

The gain_{gr} will be adjusted according to the available bits.

The lower bounds can be derived under the constraint of the zero bands. The zero bands occur when the noise is greater than the signal energy; that is

$${Δ}_{q}^{2} = {( {2}^{\frac{3}{4} ( {gain}_{g r} - {Dscale}_{q} )} )}^{2} < {\{ E [ {\vert {XR}_{q} \vert}^{0.5} ] \}}^{\frac{3}{4}} \qquad ( 22 )$$

Thus, the lower bound on the scale will be

$${scale}_{q} \geq {Dscale}_{q} = {gain}_{g r } - \frac{1}{2} {log}_{2} E [ {\vert {XR}_{q} \vert}^{0.5} ] \qquad ( 23 )$$

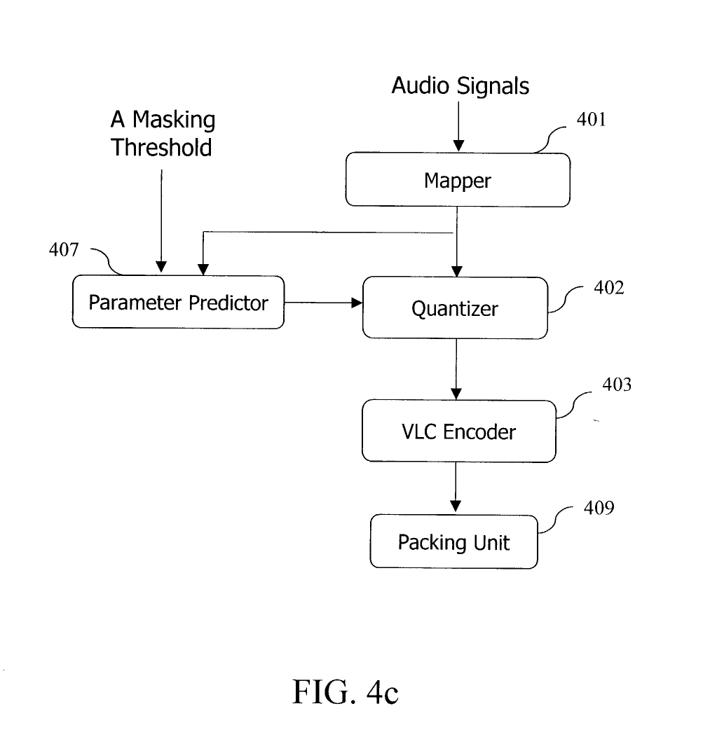

FIG. 5 illustrates the average iteration number with different testing material for the present invention and the MPEG bit allocation process respectively, where Q is the quality-controlling iterations and R is the rate-controlling iterations. As shown in FIG. 5, the allocation method of the present invention has removed the iterations required for the quality-controlling iteration and have reduced the rate controlling iterations by a factor more than three.

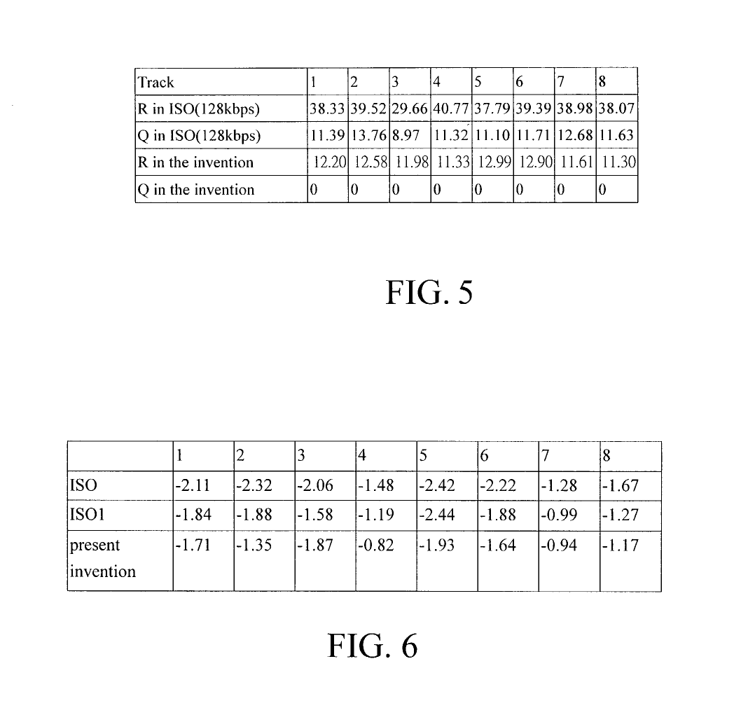

FIG. 6 illustrates the objective score of the method of the invention compared to the bit allocation method in ISO. Here the invention adopts PEAQ (perceptual evaluation of audio quality) system which is the recommendation system by ITU-R Task Group 10/4. ISO is the original source code. ISO1 is improved by adopting the termination condition used in Lame. The experiment is based on the stereo mode and the psychoacoustic model 2. Also, since the MS switch and bit reservoir are not related to the bit allocation method, the two mechanisms have been turned off in the experiment. The objective difference grade (ODG) is the output variable from the objective measurement method. The ODG values should ideally range from 0 to −4, where 0 corresponds to an imperceptible impairment and −4 to an impairment judged as very annoying. As shown in FIG. 6, the quality from the method of the present invention is better than the suggested method in the draft.

The configuration adopted in this invention for PEAQ is the basic version. The basic version uses the FFT-based ear model. It uses the following model output variables: BandwidthRef_{B}, BandwidthTest_{B}, Total NMR_{B}, WinModDiff1_{B}, ADB_{B}, EHS_{B}, AvgModDiff1_{B}, AvgModDiff2_{B}, RmsNoiseLoud_{B}, MFPD_{B} and RelDistFrames_{B}. These 11 model output variables are mapped to a single quality index using an artificial neural network with three nodes in the hidden layer.

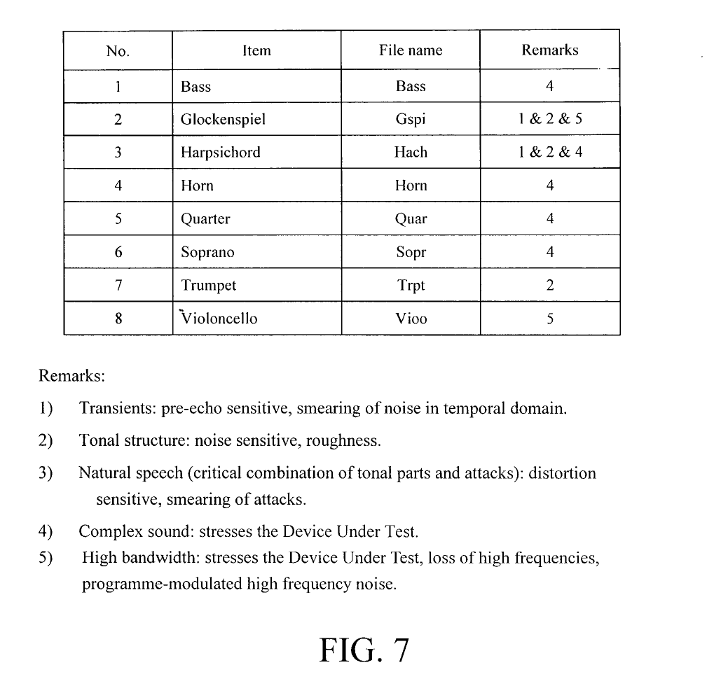

FIG. 7 provides a list with a subset of test signals that were used during the objective and subjective test. By setting the same iteration termination conditions like iteration number, the non-increasing noise scale factor bands, fitting to scale factor table, etc [website http://www.mp3dev.org/mp3.], the ISO algorithm can be improved by the method mentioned in Lame (which is generally referred to as the mp3 encoder with best quality). The two nested loops adopted for the comparison is based on the iteration algorithm used in Lame.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of digital coding for transmitting and packing audio signals, comprising the steps of:
(a) mapping input audio signals into a sequence of frequency samples representing a spectral composition of said audio signals;
(b) quantizing said sequence of frequency samples into quantized values in accordance with a bit allocation process, said bit allocation process using a parameter predictor for evaluating quantization parameters by referring to a masking threshold;
(c) encoding said quantized values using a symbol encoder to form encoded data comprising a number of bits; and
(d) packing said encoded data into a sequence of data according to a specified audio protocol.

2. The method of digital coding for transmitting and packing audio signals as claimed in claim 1, wherein said step (b) is performed either through a uniform quantizer or a non-uniform quantizer.

3. The method of digital coding for transmitting and packing audio signals as claimed in claim 1, wherein said symbol encoder comprises a VLC encoder.

4. The method of digital coding for transmitting and packing audio signals as claimed in claim 1, wherein said parameter predictor in said bit allocation process uses a deterministic formula based on a constant masking-to-noise ratio to calculate and adjust at least one corresponding global factor and/or one band scaling factor for a quantization band.

5. The method of digital coding for transmitting and packing audio signals as claimed in claim 4, wherein said bit allocation process in said step (b) further comprises the steps of adjusting said global factor according to a prescribed number of bits available for said encoded data, and yielding an upper bound and a lower bound of said band scaling factor corresponding to said global factor for a quantization band.

6. The method of digital coding for transmitting and packing audio signals as claimed in claim 5, wherein said upper bound is constrained by a non-negative noise-to-masking ratio.

7. The method of digital coding for transmitting and packing audio signals as claimed in claim 5, wherein said lower bound is constrained by zero bands.

8. The method of digital coding for transmitting and packing audio signals as claimed in claim 4, wherein said band scaling factor varies for each sub-band according to said masking threshold and said input audio signals.

9. The method of digital coding for transmitting and packing audio signals as claimed in claim 4, wherein said global factor varies with a bit rate related constant.

10. The method of digital coding for transmitting and packing audio signals as claimed in claim 1, further having an iterative rate control loop before said step (d), said iterative rate control loop comprising the steps of:
(c1) continuing said step (d) if said number of bits comprised in said encoded data does not exceed a prescribed number of bits available for said encoded data, otherwise continuing step (c2);
(c2) adjusting quantization parameters and a quantization step size to be used in step (b), and returning to step (b).

11. The method of digital coding for transmitting and packing audio signals as claimed in claim 10, wherein said step (b) is performed either through a uniform quantizer or non-uniform quantizer.

12. The method of digital coding for transmitting and packing audio signals as claimed in claim 10, wherein if said number of bits comprised in said encoded data exceeds a prescribed number of bits available for said encoded data, then at least one corresponding global factor and one band scaling factor are adjusted and said quantization step size is increased in said step (c2).

13. The method of digital coding for transmitting and packing audio signals as claimed in claim 10, wherein said symbol encoder comprises a VLC encoder.

14. The method of digital coding for transmitting and packing audio signals as claimed in claim 10, wherein said step (b) further comprises a step of cutting off high frequency for a low bit-rate audio coding before quantizing said sequence of frequency samples.

15. The method of digital coding for transmitting and packing audio signals as claimed in claim 14, wherein said step (c2) of said iterative rate control loop further includes adjusting a cut-off frequency for said step of cutting off high frequency.

16. The method of digital coding for transmitting and packing audio signals as claimed in claim 10, wherein said parameter predictor in said bit allocation process uses a deterministic formula based on a constant masking-to-noise ratio to calculate and adjust at least one corresponding global factor and/or one band scaling factor for a quantization band.

17. The method of digital coding for transmitting and packing audio signals as claimed in claim 16, wherein said bit allocation process in said step (b) further comprises the steps of adjusting said global factor according to a prescribed number of bits available for said encoded data, and yielding an upper bound and a lower bound of said band scaling factor corresponding to said global factor for a quantization band.

18. The method of digital coding for transmitting and packing audio signals as claimed in claim 17, wherein said upper bound is constrained by a non-negative noise-to-masking ratio.

19. The method of digital coding for transmitting and packing audio signals as claimed in claim 17, wherein said lower bound is constrained by zero bands.

20. The method of digital coding for transmitting and packing audio signals as claimed in claim 16, wherein said band scaling factor varies for each sub-band according to said masking threshold and said input audio signals.

21. The method of digital coding for transmitting and packing audio signals as claimed in claim 16, wherein said global factor varies with a bit rate related constant.

22. An architecture of digital coding for transmitting and packing audio signals, comprising:
a mapper transforming input audio signals into a sequence of frequency samples representing a spectral composition of said audio signals;
a parameter predictor evaluating quantization parameters by referring to a masking threshold;
a quantizer quantizing said sequence of frequency samples into quantized values in accordance with said quantization parameters;
a variable length encoder encoding said quantized values into encoded data comprising a number of bits; and
a packing unit packing said encoded data into a sequence of data according to a specified audio protocol.

23. The architecture of digital coding for transmitting and packing audio signals as claimed in claim 22, further comprising:
a comparator comapring said number of bits comprised in said encoded data with a prescribed number of bits available for said encoded data; and
an adjustor for adjusting said quantization parameters when said number of bits comprised in said encoded data exceeds said prescribed number of bits available for said encoded data.

24. The architecture of digital coding for transmitting and packing audio signals as claimed in claim 23, further comprising a high frequency cut-off unit connected between said mapper and said quantizer, said high frequency cut-off unit having an input for receiving a cut-off frequency from said adjustor.
